(19) United States
(12) Patent Application Publication
(10) Pub. No.: US 2018/0089554 A1
(43) Pub. Date: Mar. 29, 2018

(54) EXPLICIT KNOWLEDGE CONVERSION ASSISTANCE APPARATUS, EXPLICIT KNOWLEDGE CONVERSION ASSISTANCE METHOD, AND COMPUTER-READABLE STORAGE MEDIUM

(71) Applicants: NEC Solution Innovators, Ltd., Tokyo (JP); KEIO UNIVERSITY, Tokyo (JP)

(72) Inventors: Dai KUSUI, Tokyo (JP); Hideo SHIMAZU, Tokyo (JP); Atsushi SHINJO, Kanagawa (JP)

(73) Assignees: NEC Solution Innovators, Ltd., Tokyo (JP); KEIO UNIVERSITY, Tokyo (JP)

(21) Appl. No.: 15/718,855

(22) Filed: Sep. 28, 2017

(30) Foreign Application Priority Data
Sep. 29, 2016 (JP) 2016-192264

(51) Int. Cl. G06N 3/00; G06N 5/04

(52) U.S. Cl. CPC G06N 3/006; G06N 5/048

(57) ABSTRACT

An explicit knowledge conversion assistance apparatus 100 includes: a table acquisition unit 10 that acquires a table in which, for each agricultural task for a specific crop, an influence degree indicating influence that the agricultural task has on an outcome, a type of skill required for the agricultural task, and a level of a worker required for the agricultural task are defined by numerical values; an evaluation value calculation unit 20 that, for each agricultural task, calculates an evaluation value based on the values for the influence degree, the type of skill, and the level, using the table; and a priority rank setting unit 30 that sets a priority rank for each agricultural task based on the calculated evaluation value.

### CROSS-REFERENCE TO RELATED APPLICATION

This application is based upon and claims the benefit of priority from Japanese patent application No. 2016-192264, filed on Sep. 29, 2016, the disclosure of which is incorporated herein in its entirety by reference.

### BACKGROUND OF THE INVENTION

### 1. Field of the Invention

The present invention relates to an explicit knowledge conversion assistance apparatus that assists in converting know-how of an agricultural task into explicit knowledge, an explicit knowledge conversion assistance method, and a computer-readable storage medium storing a program for realizing them.

### 2. Background Art

Conventionally, many books describing various agricultural tasks in the agriculture field have been published. For example, Document 1 discloses know-how with a focus on the most important pruning in mandarin orange production. Also, Document 2 discloses know-how relating to pest control for fruit trees. Furthermore, Document 3 discloses know-how relating to tomato farming using photographs and illustrations, with a focus on fertilizer addition, watering, hormone treatment, and the like.

Thus, according to Documents 1 to 3, a producer can acquire know-how relating to agricultural tasks without studying under an expert. Accordingly, even a producer with little experience can ensure some amount of yield in the production of a crop. Also, many other books describing crops have been published in addition to Documents 1 to 3.

Document 1: Kawata, Kenji “Growing High-Sugar-Content Re-bred Mandarin Oranges—Pruning and Rat's Tail Fescue Grass Farming”, Rural Culture Association Japan, April 2002

Document 2: Tashiro, Nobuya “Pest Control For Fruit Trees—Done Easily and With Reduced Pesticides”, Rural Culture Association Japan, September 2007

Document 3: Goto, Satomi “New Edition Summer and Fall Tomato Farming Manual: Viewpoints and Methods for Growing that Anyone Can Do”, Rural Culture Association Japan, Mar. 12, 2015

Incidentally, the content of a book is insufficient for achieving better quality and a greater yield, and a producer needs to acquire know-how from personal experience and combine acquired know-how to perform various agricultural tasks. Also, the know-how needed for an agricultural task sometimes changes depending on the region. For this reason, for a further development of agriculture, it is necessary to extract even more know-how for various crops and to convert the extracted know-how into data that can be used by anyone.

However, due to the fact that there are very many types of agricultural tasks for each crop and each region, it is thought that there is a vast amount of know-how that has not yet been converted into data. Also, due to the fact that it is difficult to convert all know-how into data at once, conversion into data should be performed in sequence starting with the most important know-how. However, it is difficult even for an expert to give a priority rank to know-how.

### SUMMARY OF THE INVENTION

An example of an object of the present invention is to provide an explicit knowledge conversion assistance apparatus, an explicit knowledge conversion assistance method, and a computer-readable storage medium, according to which the above-described problems can be solved and priority ranks can be set for agricultural tasks when know-how relating to agricultural tasks is to be converted into explicit knowledge.

In order to achieve the above-described object, an explicit knowledge conversion assistance apparatus according to an aspect of the present invention includes:

a table acquisition unit configured to acquire a table in which, for each agricultural task for a specific crop, an influence degree indicating influence that the agricultural task has on an outcome, a type of skill required for the agricultural task, and a level of a worker required for the agricultural task are defined by numerical values;

an evaluation value calculation unit configured to, for each agricultural task, calculate an evaluation value based on the values for the influence degree, the type of skill, and the level, using the table; and

a priority rank setting unit configured to set a priority rank for each agricultural task based on the calculated evaluation value.

Also, in order to achieve the above-described object, an explicit knowledge conversion assistance method according to an aspect of the present invention includes:

(a) a step of acquiring a table in which, for each agricultural task for a specific crop, an influence degree indicating influence that the agricultural task has on an outcome, a type of skill required for the agricultural task, and a level of a worker required for the agricultural task are defined by numerical values;

(b) a step of, for each agricultural task, calculating an evaluation value based on the values for the influence degree, the type of skill, and the level, using the table; and

(c) a step of setting a priority rank for each agricultural task based on the calculated evaluation value.

Furthermore, in order to achieve the above-described object, a computer-readable storage medium according to an aspect of the present invention stores a program including commands for causing a computer to execute:

(a) a step of acquiring a table in which, for each agricultural task for a specific crop, an influence degree indicating influence that the agricultural task has on an outcome, a type of skill required for the agricultural task, and a level of a worker required for the agricultural task are defined by numerical values;

(b) a step of, for each agricultural task, calculating an evaluation value based on the values for the influence degree, the type of skill, and the level, using the table; and

(c) a step of setting a priority rank for each agricultural task based on the calculated evaluation value.

As described above, according to the present invention, it is possible to set priority ranks for agricultural tasks when know-how relating to agricultural tasks is to be converted into explicit knowledge.

### BRIEF DESCRIPTION OF THE DRAWINGS

FIG. 1 is a block diagram showing a schematic configuration of an explicit knowledge conversion assistance apparatus according to an embodiment of the present invention.

FIG. 2 is a block diagram showing a specific configuration of an explicit knowledge conversion assistance apparatus according to an embodiment of the present invention.

FIG. 3 is a diagram showing an example of an agricultural task table used in an embodiment of the present invention.

FIG. 4A is a diagram showing an example of outcome data and evaluation data for each producer performing a specific agricultural task, which is used in an embodiment of the present invention, and FIG. 4B is a diagram showing an example of correlational coefficients for each agricultural task measured in an embodiment of the present invention.

FIG. 5 is a flow diagram showing operations performed by an explicit knowledge conversion assistance apparatus according to an embodiment of the present invention at a time of calculating evaluation values for each agricultural task.

FIG. 6 is a flow diagram showing operations performed by an explicit knowledge conversion assistance apparatus according to an embodiment of the present invention at a time of updating an agricultural task table.

FIG. 7 is a block diagram showing an example of a computer that realizes an explicit knowledge conversion assistance apparatus according to an embodiment of the present invention.

### EXEMPLARY EMBODIMENTS

### Embodiment

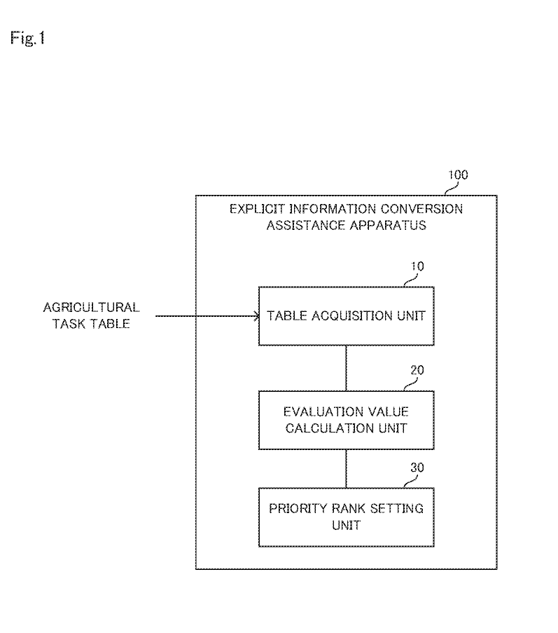

Hereinafter, an explicit knowledge conversion assistance apparatus, an explicit knowledge conversion assistance method, and a program according to an embodiment of the present invention will be described with reference to FIGS. 1 to 6.

### Configuration of Apparatus

First, a schematic configuration of an explicit knowledge conversion assistance apparatus according to the present embodiment will be described with reference to FIG. 1. FIG. 1 is a block diagram showing a schematic configuration of an explicit knowledge conversion assistance apparatus according to an embodiment of the present invention.

An explicit knowledge conversion assistance apparatus 100 according to the present embodiment shown in FIG. 1 is an apparatus for assisting the conversion of know-how of an agricultural task into explicit knowledge. As shown in FIG. 1, the explicit knowledge conversion assistance apparatus 100 includes a table acquisition unit 10, an evaluation calculation unit 20, and a priority rank setting unit 30.

The table acquisition unit 10 acquires an agricultural task table. For each agricultural task for a specific crop, an influence degree indicating the influence of the agricultural task on the outcome, a type of skill needed for the agricultural task, and a level of a worker required for the agricultural task are defined by numerical values in the agricultural task table.

For each agricultural task, the evaluation value calculation unit 20 uses the acquired agricultural task table to calculate an evaluation value based on the values for the influence degree, type of skill (skill type), and level of the worker (worker level). The priority rank setting unit 30 sets the priority ranks for the agricultural tasks based on the calculated evaluation values.

Thus, in the present embodiment, in the case where a vast number of agricultural tasks exist, logical evaluation values are calculated for the agricultural tasks. Accordingly, with the present embodiment, when know-how relating to agricultural tasks is to be converted into explicit knowledge, it is possible to set priority ranks for the agricultural tasks and it is possible to promote conversion into explicit knowledge.

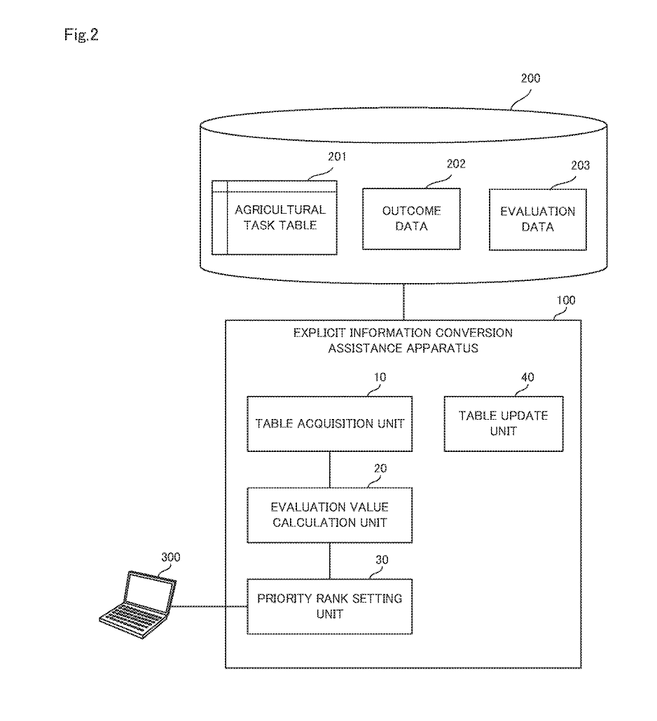

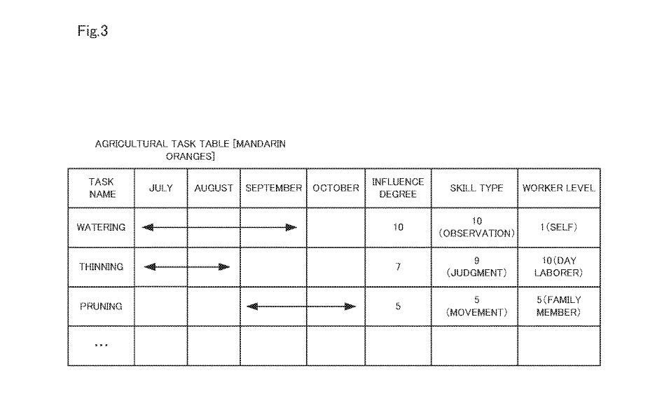

Next, a configuration of the explicit knowledge conversion assistance apparatus 100 according to the present embodiment will be described in further detail with reference to FIGS. 2 and 3. FIG. 2 is a block diagram showing a specific configuration of an explicit knowledge conversion assistance apparatus according to an embodiment of the present invention. FIG. 3 is a diagram showing an example of an agricultural task table used in an embodiment of the present invention.

As shown in FIG. 2, in the present embodiment, the explicit knowledge conversion assistance apparatus 100 is connected to a database 200 and a terminal apparatus 300 of a manager via a network. An agricultural task table 201 is stored in the database 200. Accordingly, in the present embodiment, the table acquisition unit 10 acquires the agricultural task table 201 by accessing the database 200.

As shown in FIG. 3, for each agricultural task for a specific crop, the influence degree, skill type, and worker level are defined by numerical values in the agricultural task table 201. Also, in the example shown in FIG. 3, an agricultural task table used in the case where the specific crop is mandarin oranges is shown. Also, only watering, thinning, and pruning are illustrated as the agricultural tasks, but the agricultural tasks are not limited to these.

Also, in the present embodiment, the influence degree is set within a range of 1 to 10. The skill type is set using numerical values provided for each type. Also, the worker level is set using numerical values provided for each type of worker. Furthermore, in the agricultural task table, the values for the influence degree, the skill type, and the worker level are set by a manager, a specialist, or the like based on performance and experience. In addition, agricultural task tables may be created for each crop in each specific region.

Also, in the present embodiment, for each agricultural task, the evaluation value calculation unit 20 can calculate an evaluation value by multiplying the values for the influence degree, the skill type, and the worker level by weight set in advance for each value and adding together the obtained products. Here, letting a, b, and c be the respective values for the influence degree, the skill type, and the worker level and w1, w2, and w3 be the weights set for the respective values, the evaluation value is calculated using Equation 1 below.

Evaluation value=a×w1+b×w2+c×w3 Equation 1

Also, after determining the priority rank of an agricultural task based on the evaluation value, in the present embodiment, the priority rank setting unit 30 transmits data specifying the priority ranks and the evaluation values of the agricultural tasks to the terminal apparatus 300 of the manager. Upon receiving the data, the terminal apparatus 300 displays the priority ranks and the evaluation values of the agricultural tasks specified using the received data on a display screen. Accordingly, the manager can check an agricultural task that is to be converted into explicit data with a high priority degree.

Also, as shown in FIG. 2, in the present embodiment, the explicit knowledge conversion assistance apparatus 100 includes a table update unit 40 in addition to the table acquisition unit 10, the evaluation value calculation unit 20, and the priority rank setting unit 30.

The table update unit 40 first acquires outcome data 202 and evaluation data 203. The outcome data is data specifying the outcome of a crop, and the evaluation data is data specifying evaluations of the agricultural tasks performed by a producer of the crop. In the present embodiment, the outcome data 202 and the evaluation data 203 are stored in the database 200 for each producer.

Specifically, the outcome data 202 is data that includes the harvest amount per unit area of the crop, the quality of the crop (sugar content, size, etc.), evaluation points of the crop (a value calculated based on the sugar content, acidity, size, appearance (color, existence of blemishes), etc.), and the like. The outcome data may include only one of these numerical values, or may include two or more thereof.

Furthermore, the outcome data 202 may include the product of multiplying the evaluation points and the harvest amount per unit area, the product of multiplying the evaluation points and a shipping amount, and the like. Also, using the case of mandarin oranges as an example, specific examples of the evaluation points include evaluation points calculated using a calculation equation set by the National Federation of Agricultural Cooperative Associations (JA). Note that the evaluation points for mandarin oranges are usually calculated using a dedicated fruit grader.

Also, specifically, the evaluation data 203 is data that indicates, as a numerical value, an evaluation given to the agricultural task of a target producer by an agricultural road instructor or an exemplary farmer of the National Federation of Agricultural Cooperative Associations. For example, the numerical value is set based on a reference set in advance within a range of 20 to 100.

The table update unit 40 obtains correlative coefficients of the outcomes of the specific crop and the evaluations of the agricultural tasks for the specific crop based on the acquired outcome data 202 and evaluation data 203, and updates the numerical values for the influence degrees in the agricultural task table based on the obtained correlative coefficients.

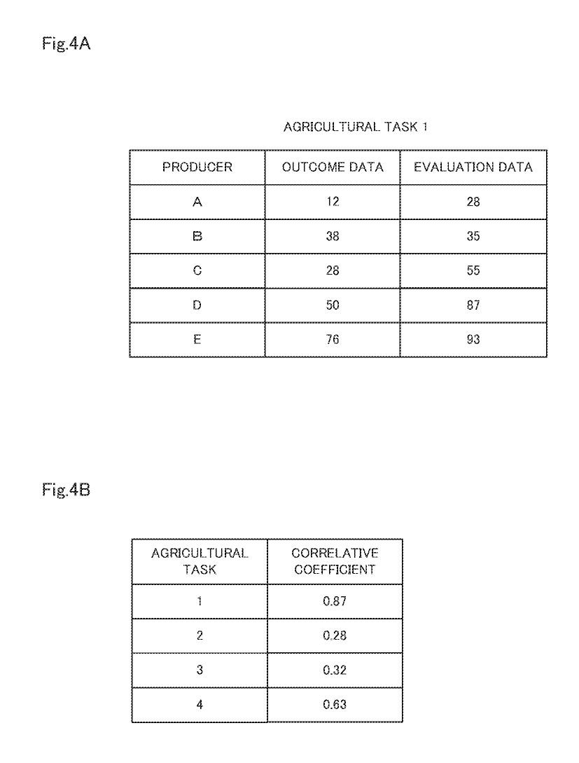

Specifically, the table update unit 40 specifies the outcome data 202 and the evaluation data 203 for the producers for each agricultural task (see FIGS. 4A and 4B). Then, for each agricultural task, the table update unit 40 obtains the standard deviation of the specified outcome data and the standard deviation of the evaluation data and furthermore obtains the covariance of the outcome data and the evaluation data. Thereafter, for each agricultural task, the table update unit 40 calculates the correlative coefficient by applying the obtained standard deviations and covariance and applying them to Equation 2 below.

Correlative coefficient=Covariance÷(standard deviation of evaluation data×standard deviation of outcome data) Equation 2

The calculation results will be indicated with reference to FIGS. 4A and 4B. FIG. 4A is a diagram showing an example of outcome data and evaluation data for each producer for a specific crop, which is used in an embodiment of the present invention, and FIG. 4B is a diagram showing an example of correlative coefficients for each agricultural task calculated in the embodiment of the present invention.

For an agricultural task 1, the table update unit 40 specifies the outcome data 202 and the evaluation data 203 shown in FIG. 4A. Also, as shown in FIG. 4B, the table update unit 40 calculates correlative coefficients for each of the agricultural tasks 1 to 4.

Also, it is thought that the higher the correlative coefficient of an agricultural task is, the greater the harvest amount and the better the quality will be if the agricultural task is done skillfully. Accordingly, by comparing the correlative coefficients of the agricultural tasks, it is possible to specify an agricultural task with a high degree of influence on the outcome.

Accordingly, the table update unit 40 uses the calculated correlative coefficients to update the values for the influence degrees of the agricultural tasks in the agricultural task table. Specifically, for example, the table update unit 40 multiplies the correlative coefficients shown in FIG. 4B by 10 and replaces the influence degrees in the agricultural task table with the obtained products.

Also, the table update unit 40 can use the correlative coefficients for each agricultural task for multiple crops of similar types to obtain an average value of the correlative coefficients for the agricultural tasks, and can use the obtained average value to update the values of the influence degrees of the agricultural tasks in the agricultural task table. Note that in the case of mandarin oranges, examples of the multiple crops that are similar in type include types such as satsuma oranges (among these, “Miyakawa-wase”, “Obarabeni-wase”, etc.) and mid-to-late-ripening citrus fruit.

### Operation of Apparatus

Next, operations performed by the explicit knowledge conversion assistance apparatus 100 according to the present embodiment will be described. In the following description, FIG. 1 will be referenced as needed. Also, in the present embodiment, an explicit knowledge conversion assistance method is carried out by causing the explicit knowledge conversion assistance apparatus 100 to operate. Accordingly, the description of the explicit knowledge conversion assistance method according to the present embodiment will be substituted with the following description of the operations performed by the explicit knowledge conversion assistance apparatus 100.

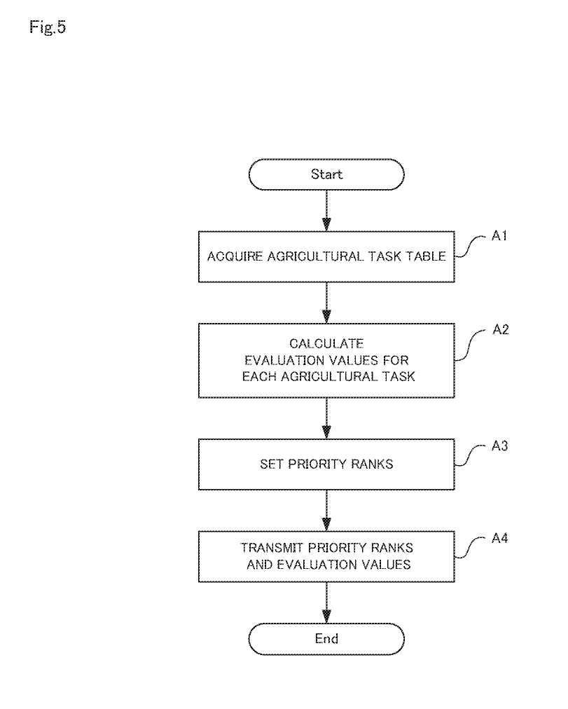

First, operations performed when the explicit knowledge conversion assistance apparatus 100 calculates the evaluation values will be described. FIG. 5 is a flow diagram showing operations performed by an explicit knowledge conversion assistance apparatus according to an embodiment of the present invention at a time of calculating evaluation values for each agricultural task.

As shown in FIG. 5, first, the table acquisition unit 10 acquires the agricultural task table 201 for a specific crop by accessing the database 200 (step A1).

Next, the evaluation value calculation unit 20 uses the agricultural task table 201 acquired in step A1 to specify the values for the influence degree, the skill type, and the worker level for each agricultural task, and calculates the evaluation values based on the specified values (step A2). Specifically, the evaluation value calculation unit 20 calculates the evaluation values by substituting the values and the weights into Equation 1 above.

Next, based on the evaluation values calculated in step A2, the priority rank setting unit 30 sets the priority ranks of the agricultural tasks shown in the agricultural task table (step A3). Specifically, the priority rank setting unit 30 determines the ranks in sequence starting from the agricultural task with the highest evaluation value.

Next, the priority rank setting unit 30 generates data for specifying the priority rank determined in step A3 and the evaluation values calculated in step A2 and transmits the generated data to the terminal apparatus 300 (step A4). Accordingly, the manager can check an agricultural task that is to be converted into explicit data with a high priority degree on the screen of the terminal apparatus 300.

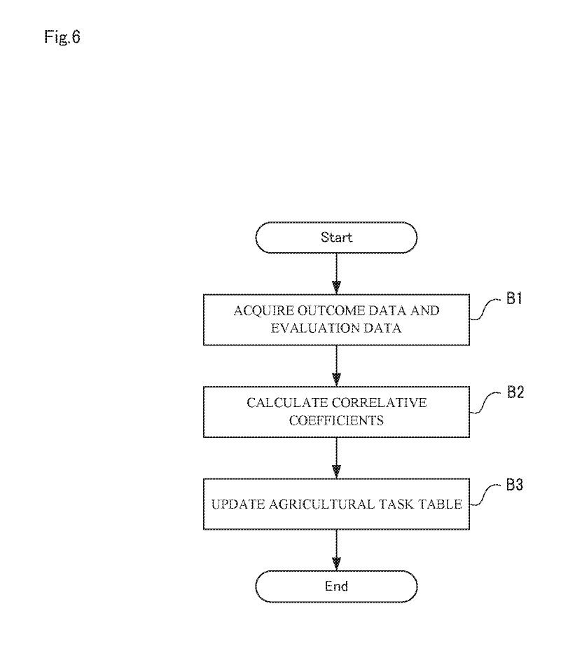

Next, operations performed when the explicit knowledge conversion assistance apparatus 100 updates the agricultural task table will be described. FIG. 6 is a flow diagram showing operations performed by an explicit knowledge conversion assistance apparatus according to an embodiment of the present invention at a time of updating an agricultural task table.

As shown in FIG. 6, first, the table update unit 40 acquires the outcome data 202 and the evaluation data 203 by accessing the database 200 (step B1).

Next, the table update unit 40 calculates correlative coefficients for the outcome of the specific crop and the evaluations of the agricultural tasks for the specific crop based on the outcome data 202 and the evaluation data 203 acquired in step B1 (step B2). Specifically, in step B2, the table update unit 40 uses the above-described Equation 2 to calculate correlative coefficients for each agricultural task for the specific crop.

Next, the table update unit 40 updates the values for the influence degrees in the agricultural task table for the specific crop based on the correlative coefficients calculated in step B2 (step B3). Accordingly, optimization of the agricultural task table 201 is achieved.

### Effect of the Embodiment

As described above, according to the present embodiment, evaluation values for agricultural tasks are calculated for each crop, and therefore when know-how relating to the agricultural tasks for a crop is to be converted into explicit knowledge, priority ranks can be set for the agricultural tasks, and it is possible to promote conversion into explicit knowledge. Also, in the present embodiment, the agricultural task table on which the calculation of the evaluation values is based is updated according to performance and evaluation, and therefore the calculated evaluation values are optimized, which increases reliability.

### Program

A program according to the present embodiment need only be a program for causing a computer to execute steps A1 to A4 shown in FIG. 5. The explicit knowledge conversion assistance apparatus 100 and the explicit knowledge conversion assistance method of the present embodiment can be realized by installing the program in a computer and executing it. In this case, a CPU (Central Processing Unit) of the computer functions as the table acquisition unit 10, the evaluation value calculation unit 20, the priority rank setting unit 30, and the table update unit 40 to perform processing.

Also, the program of the present embodiment may be executed by a computer system constructed by multiple computers. In this case, for example, each computer may function as one of the table acquisition unit 10, the evaluation value calculation unit 20, the priority rank setting unit 30, and the table update unit 40.

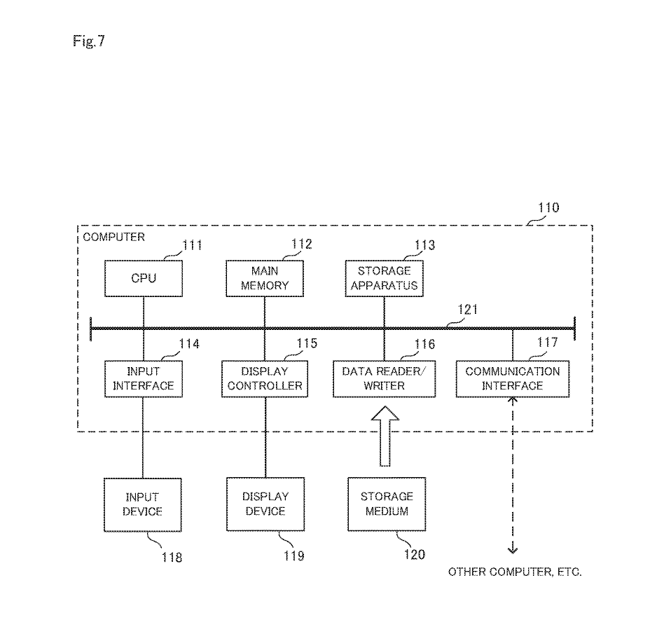

Here, a computer that realizes the explicit knowledge conversion assistance apparatus 100 by executing the program of the present embodiment will be described with reference to FIG. 7. FIG. 7 is a block diagram showing an example of a computer that realizes an explicit knowledge conversion assistance apparatus according to an embodiment of the present invention.

As shown in FIG. 7, the computer 110 includes a CPU 111, a main memory 112, a storage apparatus 113, an input interface 114, a display controller 115, a data reader/writer 116, and a communication interface 117. These units are connected via a bus 121 so as to be capable of mutual data communication.

The CPU 111 carries out various calculations by expanding programs (codes) according to the present embodiment, which are stored in the storage apparatus 113, to the main memory 112 and executing them in a predetermined sequence. The main memory 112 is typically a volatile storage device such as a DRAM (Dynamic Random Access Memory). Also, the program according to the present embodiment is provided in a state of being stored in a computer-readable storage medium 120. Note that the program according to the present embodiment may be distributed over the Internet, which is connected to via the communication interface 117.

Also, specific examples of the storage apparatus 113 include a semiconductor storage device such as a flash memory, in addition to a hard disk drive. The input interface 114 mediates data transmission between the CPU 111 and an input device 118 such as a keyboard or a mouse. The display controller 115 is connected to a display device 119 and controls display on the display device 119.

The data reader/writer 116 mediates data transmission between the CPU 111 and the storage medium 120, reads out programs from the storage medium 120, and writes results of processing performed by the computer 110 in the storage medium 120. The communication interface 117 mediates data transmission between the CPU 111 and another computer.

Also, specific examples of the storage medium 120 include a general-purpose semiconductor storage device such as CF (Compact Flash (registered trademark)) and SD (Secure Digital), a magnetic storage medium such as a flexible disk, and an optical storage medium such as a CD-ROM (Compact Disk Read Only Memory).

Note that the explicit knowledge conversion assistance apparatus 100 according to the present embodiment can be realized by using hardware corresponding to the units, instead of a computer in which a program is installed. Furthermore, the explicit knowledge conversion assistance apparatus 100 may be realized in part by a program and in part by hardware.

As described above, according to the present invention, it is possible to set priority ranks for agricultural tasks when know-how relating to agricultural tasks is to be converted into explicit knowledge.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An explicit knowledge conversion assistance apparatus comprising:
a table acquisition unit configured to acquire a table in which, for each agricultural task for a specific crop, an influence degree indicating influence that the agricultural task has on an outcome, a type of skill required for the agricultural task, and a level of a worker required for the agricultural task are defined by numerical values;
an evaluation value calculation unit configured to, for each agricultural task, calculate an evaluation value based on the values for the influence degree, the type of skill, and the level, using the table; and
a priority rank setting unit configured to set a priority rank for each agricultural task based on the calculated evaluation value.

2. The explicit knowledge conversion assistance apparatus according to claim 1, wherein
for each agricultural task, the evaluation value calculation unit calculates the evaluation value by multiplying the values for the influence degree, the type of skill, and the level by respective weights set in advance for those values and adding together the obtained products.

3. The explicit knowledge conversion assistance apparatus according to claim 1, wherein
the table is created for a specific crop in a specific region.

4. The explicit knowledge conversion assistance apparatus according to claim 1, further comprising
a table update unit configured to acquire, from an external source, first data specifying an outcome of the specific crop and second data specifying an evaluation of an agricultural task performed by a producer of the specific crop, obtain a correlative coefficient for the outcome of the specific crop and the evaluation of the agricultural task for the specific crop based on the acquired first data and second data, and update the value for the influence degree in the table based on the obtained correlative coefficient.

5. An explicit knowledge conversion assistance method comprising:
(a) a step of acquiring a table in which, for each agricultural task for a specific crop, an influence degree indicating influence that the agricultural task has on an outcome, a type of skill required for the agricultural task, and a level of a worker required for the agricultural task are defined by numerical values;
(b) a step of, for each agricultural task, calculating an evaluation value based on the values for the influence degree, the type of skill, and the level, using the table; and
(c) a step of setting a priority rank for each agricultural task based on the calculated evaluation value.

6. The explicit knowledge conversion assistance method according to claim 5, wherein
in the step (b), for each agricultural task, the evaluation value is calculated by multiplying the values for the influence degree, the type of skill, and the level by respective weights set in advance for those values and adding together the obtained products.

7. The explicit knowledge conversion assistance method according to claim 5, wherein
the table is created for a specific crop in a specific region.

8. The explicit knowledge conversion assistance method according to claim 5, further comprising
(d) a step of acquiring, from an external source, first data specifying an outcome of the specific crop and second data specifying an evaluation of an agricultural task performed by a producer of the specific crop, obtaining a correlative coefficient for the outcome of the specific crop and the evaluation of the agricultural task for the specific crop based on the acquired first data and second data, and updating the value for the influence degree in the table based on the obtained correlative coefficient.

9. A computer-readable storage medium storing a program including commands for causing a computer to execute:
(a) a step of acquiring a table in which, for each agricultural task for a specific crop, an influence degree indicating influence that the agricultural task has on an outcome, a type of skill required for the agricultural task, and a level of a worker required for the agricultural task are defined by numerical values;
(b) a step of, for each agricultural task, calculating an evaluation value based on the values for the influence degree, the type of skill, and the level, using the table; and
(c) a step of setting a priority rank for each agricultural task based on the calculated evaluation value.

10. The computer-readable storage medium according to claim 9, wherein
in the step (b), for each agricultural task, the evaluation value is calculated by multiplying the values for the influence degree, the type of skill, and the level by respective weights set in advance for those values and adding together the obtained products.

11. The computer-readable storage medium according to claim 9, wherein
the table is created for a specific crop in a specific region.

12. The computer-readable storage medium according to claim 9, further causing the computer to execute
(d) a step of acquiring, from an external source, first data specifying an outcome of the specific crop and second data specifying an evaluation of an agricultural task performed by a producer of the specific crop, obtaining a correlative coefficient for the outcome of the specific crop and the evaluation of the agricultural task for the specific crop based on the acquired first data and second data, and updating the value for the influence degree in the table based on the obtained correlative coefficient.
